(19) United States
(12) Patent Application Publication
(10) Pub. No.: US 2026/0006662 A1
(43) Pub. Date: Jan. 1, 2026

(54) COMMUNICATION CONTROL APPARATUS, COMMUNICATION CONTROL METHOD, AND COMPUTER READABLE STORAGE MEDIUM

(71) Applicant: HONDA MOTOR CO.,LTD., Tokyo (JP)

(72) Inventor: Kosei TSUSHIMA, Tokyo (JP)

(21) Appl. No.: 19/245,386

(22) Filed: Jun. 22, 2025

(30) Foreign Application Priority Data
Jun. 28, 2024 (JP) 2024-105123

(51) Int. Cl. H04W 76/15; H04W 40/04; H04W 40/34; H04W 72/56

(52) U.S. Cl. CPC H04W 76/15; H04W 40/04; H04W 40/34; H04W 72/56

(57) ABSTRACT

A communication control apparatus provided in a movable body including a cellular communication unit which performs cellular communication and a wireless LAN communication unit which performs wireless LAN communication, includes a virtual router unit which decides to route communication to the cellular communication unit or to route communication to the wireless LAN communication unit, and a control unit which performs control to communicate by prioritizing the wireless LAN communication over the cellular communication by controlling routing by the virtual router unit.

The contents of the following patent application(s) are incorporated herein by reference: NO. 2024-105123 filed in JP on June 28, 2024.

### BACKGROUND

### TECHNICAL FIELD

The present invention relates to a communication control apparatus, a communication control method, and a computer readable storage medium.

### RELATED ART

Patent documents 1 to 6 describe techniques related to a virtual router. Patent document 7 describes a technique related to communicate control in a communication control apparatus mounted to a vehicle.

### Prior Art Documents

### Patent documents

Patent Document 1: Japanese Patent Application Publication No. 2003-46538

Patent Document 2: Japanese Patent Application Publication No. 2021-7249

Patent Document 3: Japanese Patent Application Publication No. 2013-9259

Patent Document 4: International Publication No. 2013/190688

Patent Document 5: Japanese Patent Application Publication No. 2010-4088

Patent Document 6: Japanese Patent Application Publication No. 2016-208068

Patent Document 7: Japanese Patent Application Publication No. 2023-118361

Patent Document 8: Japanese Patent Application Publication No. 2020-181604

### BRIEF DESCRIPTION OF THE DRAWINGS

FIG. 1 schematically illustrates a configuration of a communication system 22 according to an embodiment.

FIG. 2 schematically illustrates an example of a system configuration included in the communication system 22.

FIG. 3 is a conceptual diagram representing routings of packets by a TCU 30.

FIG. 4 illustrates an example of a flowchart according to a communication control method performed in the TCU 30.

FIG. 5 illustrates an example of a computer 2000.

### DESCRIPTION OF EXEMPLARY EMBODIMENTS

Hereinafter, the present invention will be described by way of embodiments of the invention. However, the following embodiments are not for limiting the invention according to the claims. In addition, not all of the combinations of features described in the embodiments are necessarily essential to the solution of the invention.

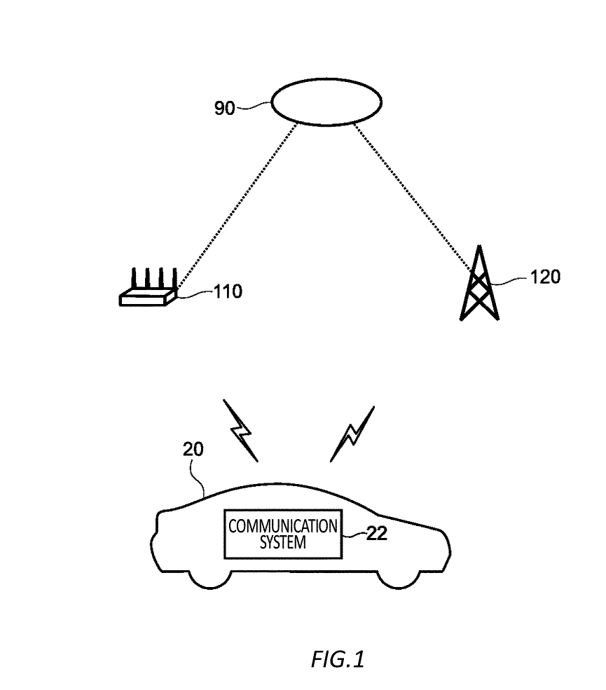

FIG. 1 schematically illustrates a configuration of a communication system 22 according to an embodiment. The communication system 22 is provided in a movable body 20.

The movable body 20 is movable equipment. The movable body 20 is, for example, an automobile such as a bus or a vehicle such as a train. The vehicle is an example of transportation equipment. The movable body 20 may be various aircrafts or the like including an unmanned air vehicle.

The communication system 22 has functions to perform cellular communication and wireless LAN communication. The communication system 22 can communicate with communication equipment connected to a communication network 90 through a wireless relay apparatus 110 and a wireless base station 120. The communication network 90 includes a computer network such as the Internet, a cellular communication network, or the like.

The wireless base station 120 is a cellular communication base station supporting one or more cellular communication schemes. The cellular communication schemes supported by the wireless base station 120 may be, for example, communication schemes used in mobile communication systems such as a fourth generation mobile communication system (4G) and a fifth generation mobile communication system (SG). The wireless base station 120 relays communication between a communication apparatus in the communication system 22 and communication equipment connected to the communication network 90.

The wireless relay apparatus 110 has a function of relaying the wireless LAN communication. The wireless relay apparatus 110 has a wireless LAN access point function, for example. The wireless relay apparatus 110 relays the communication between the communication apparatus in the communication system 22 and the communication equipment connected to the communication network 90.

The movable body 20 is a vehicle in the present embodiment, and the communication system 22 includes a plurality of communication apparatuses connected to a communication network in the vehicle. The plurality of communication apparatuses connected to the communication network in the vehicle include, for example, an electric control unit (ECU) included in the vehicle.

When the cellular communication through the wireless base station 120 and the wireless LAN communication through the wireless relay apparatus 110 are available, the communication system 22 prioritizes the wireless LAN communication over the cellular communication. With this configuration, communication costs can be reduced.

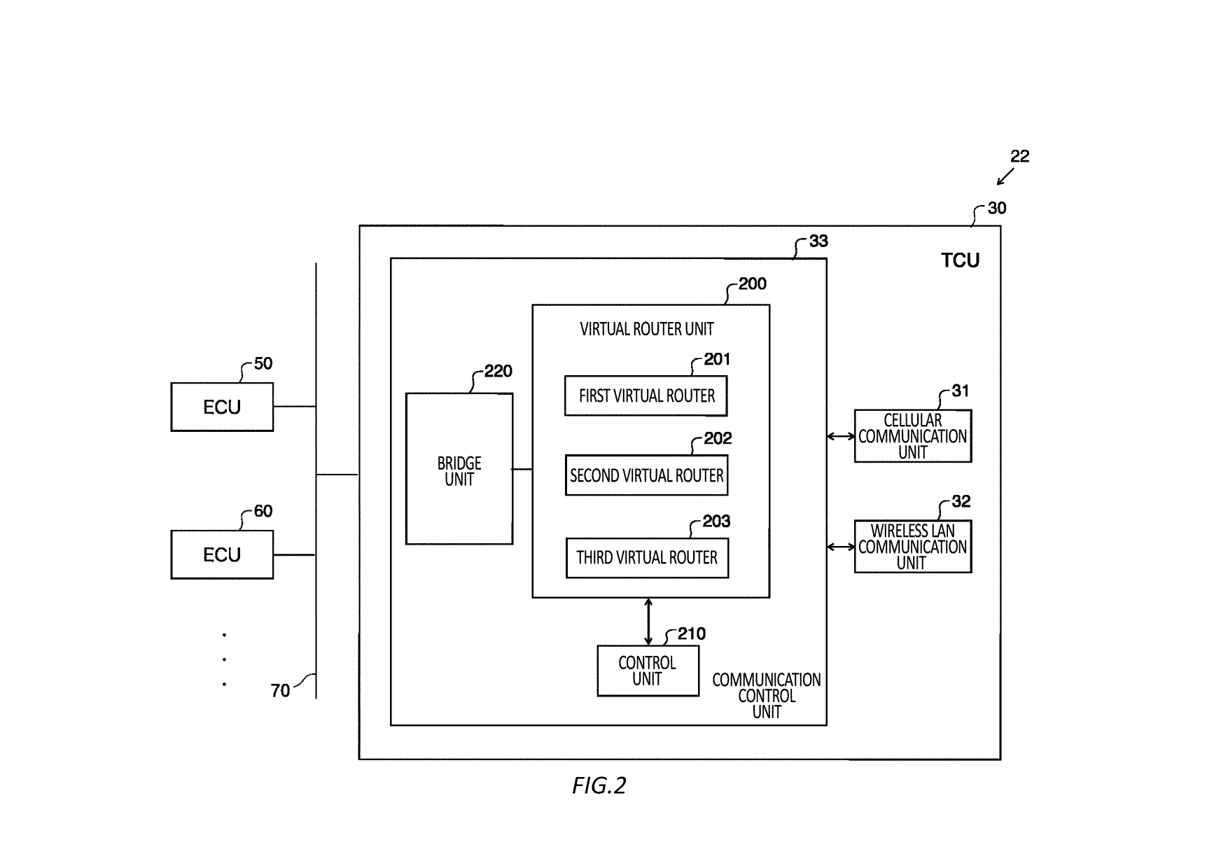

FIG. 2 schematically illustrates an example of a system configuration included in the communication system 22. The communication system 22 includes a TCU 30, an in-vehicle communication network 70, and a plurality of ECUs including a ECU 50 and a ECU 60. The in-vehicle communication network 70 includes, for example, an ETHERNET (registered trademark) bus and an ETHERNET (registered trademark) hub.

The TCU 30 is a telematics control unit. The TCU 30 includes a control unit 210, a cellular communication unit 31, and a wireless LAN communication unit 32.

The cellular communication unit 31 performs cellular communication, and the wireless LAN communication unit 32 performs wireless LAN communication.

A communication control unit 33 is responsible for overall control of the entire TCU 30. The communication control unit 33 is an example of a communication control apparatus. At least part of the communication control unit 33 is achieved by an arithmetic processing device including a processor. The communication control unit 33 may be achieved by a computer including a CPU, a ROM, a RAM, an I/O, a bus, and the like.

The communication control unit 33 includes a bridge unit 220, a virtual router unit 200, and the control unit 210. The virtual router unit 200 includes a first virtual router 201, a second virtual router 202, and a third virtual router 203.

The virtual router unit 200 decides to route communication to the cellular communication unit 31 or to route communication to the wireless LAN communication unit 32. The control unit 210 performs control to communicate by prioritizing the wireless LAN communication over the cellular communication. Specifically, by controlling routing by the virtual router unit 200, the control unit 210 performs the control to communicate by prioritizing the wireless LAN communication over the cellular communication.

In general, a standardization of the wireless LAN communication is to be updated in a much shorter cycle than a lifetime of the vehicle. According to the TCU 30, since the virtual router unit decides whether or not to route the communication to the wireless LAN communication unit 32, even when the standardization of the wireless LAN communication is changed, it is possible to support the latest wireless LAN communication by easily updating the virtual router unit without updating hardware of the TCU 30. Therefore, the control to prioritize the wireless LAN communication can be achieved over the lifetime of the vehicle. With this configuration, since it becomes possible to use the wireless LAN communication over the lifetime of the vehicle, the communication costs in the vehicle can be suppressed.

By controlling the routing by the virtual router unit 200, the control unit 210 performs control to perform the cellular communication and the wireless LAN communication in parallel. That is, the control unit 210 can perform the wireless LAN communication while the cellular communication is performed. With this configuration, even when the cellular communication can be performed, since it is possible to perform the wireless LAN communication when the wireless LAN communication can be used, a communication amount of the cellular communication can be lowered. With this configuration, the communication costs can be suppressed.

By controlling the routing by the virtual router unit 200, the control unit 210 may route communication other than communication related to travelling control of the vehicle to the wireless LAN communication unit 32 by priority over the cellular communication unit 31. For example, the wireless LAN communication is used by priority for data communication for in-vehicle infotainment (IVI) and/or data communication to use an entertainment related service. Although a security of the wireless LAN communication may be lower than that of the cellular communication, an issue in terms of the security is not significant even when the wireless LAN communication is used for the data communication for IVI and the communication to use the entertainment related service.

By controlling the routing by the virtual router unit 200, the control unit 210 may route the communication related to the travelling control of the movable body 20 to the cellular communication unit 31 by priority over the wireless LAN communication unit 32. Examples of the communication related to the travelling control of the vehicle include data to be communicated on a controller area network (CAN), control related data of a drive apparatus such as an engine, an error log, data representing a vehicle state, and the like.

The virtual router unit 200 may include a plurality of virtual routers associated with mutually different APNs. With this configuration, since the virtual routers can be set on an APN basis, routings are more easily organized compared to a case in which routings where a plurality of APNs are mixed are set. The first virtual router 201 and the second virtual router 202 may be examples of the plurality of virtual routers associated with the mutually different APNs. The first virtual router 201 may be associated with a first APN, and the second virtual router 202 may be associated with a second APN.

The virtual router unit 200 may include a plurality of virtual routers associated with mutually different services. The first virtual router 201, the second virtual router 202, and the third virtual router 203 may be examples of the plurality of virtual routers associated with the mutually different services. Although a requested security level and a requested communication quality vary for each service to be provided, what extents of the security level and the communication quality to be selected may depend on the APN. Therefore, by separating the virtual router for each APN, in many cases, the virtual router is substantially separated for each service. That is, for example, when the virtual router is separated for each APN, in many cases, since a particular service may be aggregated to a particular virtual router, setting of the virtual routers is also less likely to be complicated.

The virtual router unit 200 includes the first virtual router 201 which routes communication only to the cellular communication unit 31. The first virtual router 201 is desirably used for routing data in connection to a service which demands a high immediacy and/or demands a high security level. For example, the first virtual router 201 is desirably used for routing vehicle control related data such as data related to the travelling control of the movable body 20.

The virtual router unit 200 includes the second virtual router 202 which routes communication to the cellular communication unit 31 and the wireless LAN communication unit 32. By controlling the second virtual router 202, the control unit 210 performs control to communicate by prioritizing the wireless LAN communication over the cellular communication. Depending on the routing of the second virtual router 202, data communication may be performed through the wireless LAN communication, the second virtual router 202 is desirably used for routing data in connection to a service which demands a relatively high immediacy but demands a medium degree of the security level.

The virtual router unit 200 includes the third virtual router 203 which routes communication only to the wireless LAN communication unit 32. The third virtual router 203 is desirably used for routing data which demands a relatively low immediacy and demands a relatively low security level. For example, the third virtual router 203 is desirably used for routing the data for IVI and/or the data in connection to the entertainment related service.

When a predetermined event is detected, the control unit 210 may perform, by controlling the routing by the virtual router unit 200, control to communicate by prioritizing the wireless LAN communication over the cellular communication. For example, when the predetermined event is detected, the control unit 210 may perform, by controlling the routing by the second virtual router 202, control to communicate by prioritizing the wireless LAN communication over the cellular communication. The "predetermined event" may include an event representing that a communication state of the cellular communication becomes poor. When the movable body 20 is a vehicle, the "predetermined event" may include at least one of an event representing that a speed of the vehicle becomes less than or equal to a predetermined speed value or an event representing that an IG power source of the vehicle is turned off.

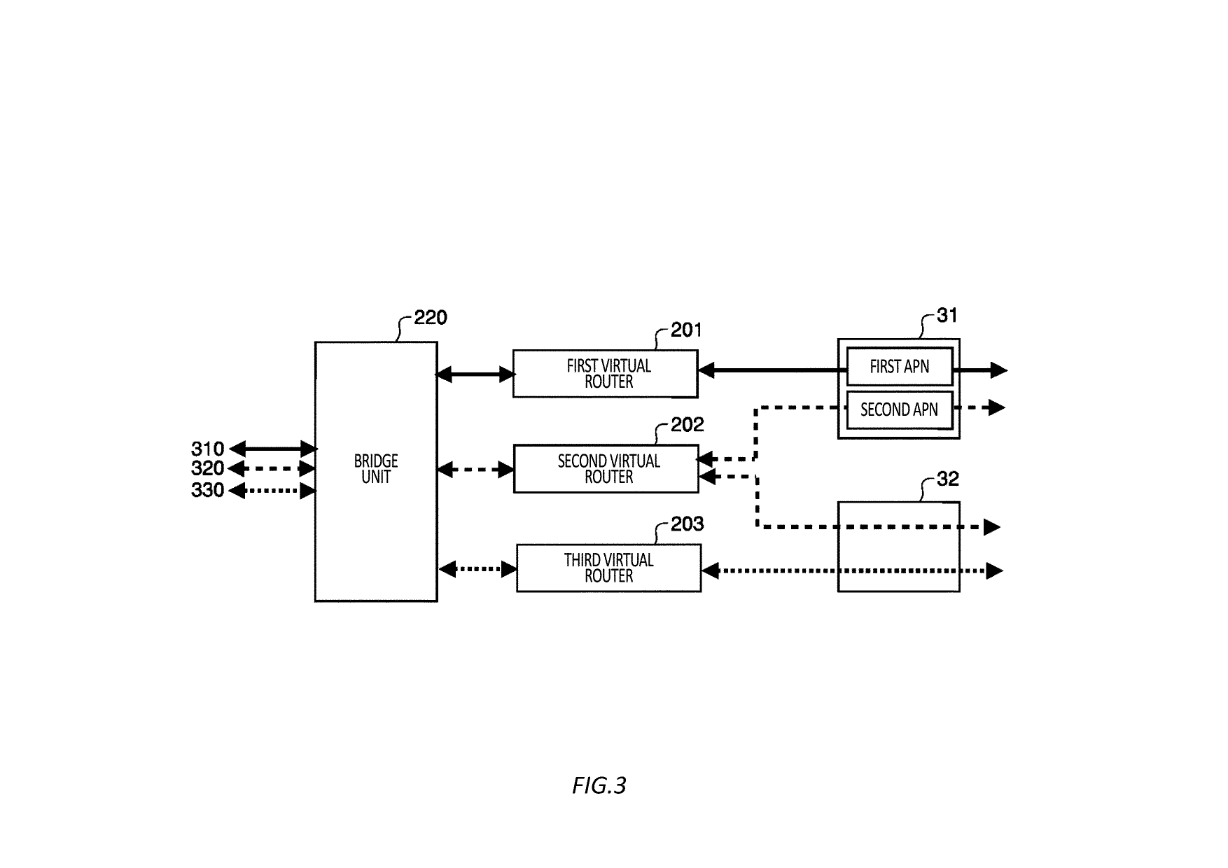

FIG. 3 is a conceptual diagram representing routings of packets by the TCU 30. In FIG. 3, it is assumed that a first packet 310 is a packet in connection to a first service, a second packet 320 is a packet in connection to a second service, and a third packet 330 is a packet in connection to a third service. As an example, the service is identified by a port number and a transmission source of the packet.

The bridge unit 220 is set to input a packet in connection to the first service to the first virtual router 201, input a packet in connection to the second service to the second virtual router 202, and input a packet in connection to the third service to the third virtual router 203.

Since the first packet 310 is the packet in connection to the first service, the first packet 310 is input to the first virtual router 201. The first virtual router 201 is a virtual router which is associated with a first APN and which routes the communication only to the cellular communication unit 31. Therefore, the first virtual router 201 inputs the input packet to the cellular communication unit 31 while being associated with the first APN. The cellular communication unit 31 converts a local IP address of the input first packet 310 into a global IP address assigned from a communication carrier associated with the first APN for transmission. With this configuration, the first packet 310 is transmitted to a communication path associated with the first APN.

Since the second packet 320 is the packet in connection to the second service, the second packet 320 is input to the second virtual router 202. The second virtual router 202 is a virtual router which is associated with a second APN and which routes the communication to the cellular communication unit 31 or the wireless LAN communication unit 32. The second virtual router 202 inputs, to the cellular communication unit 31, the packet routed to the cellular communication unit 31 among input packets based on a routing table while being associated with the second APN, and inputs, to the wireless LAN communication unit 32, the packet routed to the wireless LAN communication unit 32 among the input packets. The cellular communication unit 31 converts a local IP address of the input packet into a global IP address assigned from a communication carrier associated with the second APN. Accordingly, when the second packet 320 is set to be routed to the cellular communication unit 31 based on the routing table, the second packet 320 is transmitted to a communication path associated with the second APN. When the second packet 320 is set to be routed to the wireless LAN communication unit 32 based on the routing table, with its local IP address converted into an IP address assigned to the wireless LAN communication unit 32, the second packet 320 is transmitted to the wireless relay apparatus 110.

Since the third packet 330 is the packet in connection to the third service, the third packet 330 is input to the third virtual router 203. The third virtual router 203 is a virtual router which routes the communication to the wireless LAN communication unit 32. The third virtual router 203 inputs, to the wireless LAN communication unit 32, the packet routed to the wireless LAN communication unit 32. With its local IP address converted into an IP address assigned to the wireless LAN communication unit 32, the third packet 330 is transmitted to the wireless relay apparatus 110.

According to the example of FIG. 3, since the first virtual router 201 and the second virtual router 202 are associated with the different APNs, the routing tables in the first virtual router 201 and the second virtual router 202 may be set for the particular APNs. Since the packets in connection to the particular services are respectively input to the first virtual router 201 and the second virtual router 202, the routing tables in the first virtual router 201 and the second virtual router 202 may be set for the particular services. With this configuration, the setting of the routing tables is facilitated.

In the example illustrated in FIG. 3, the communication carrier associated with the first APN may be a communication carrier different from the communication carrier associated with the second APN. In another embodiment, the communication carrier associated with the first APN may be a same communication carrier as the communication carrier associated with the second APN.

In the example illustrated in FIG. 3, when the control unit 210 performs the control to communicate by prioritizing the wireless LAN communication over the cellular communication, by changing the routing table of the second virtual router 202, the control unit 210 may configure a setting to communicate by prioritizing the wireless LAN communication over the cellular communication. For example, the control unit 210 may change the routing table such that among the services in which the packets are set to be routed to the cellular communication unit 31, the packets in connection to at least some of the services are to be routed to the wireless LAN communication unit 32.

As an example, the control unit 210 may change the routing table such that among the services in which the packets are set to be routed to the cellular communication unit 31, at least some of the services which allow a lower security level are selected by priority, and the packets in connection to the selected services are to be routed to the wireless LAN communication unit 32. The control unit 210 may change the routing table such that among the services in which the packets are set to be routed to the cellular communication unit 31, at least some of the services which allow a lower immediacy are selected by priority, and the packets in connection to the selected services are to be routed to the wireless LAN communication unit 32. In each of the services, request information representing the security level and immediacy requested to use each of the services is preset, and the control unit 210 may refer to the request information to specify a service in which the packets are to be routed to the wireless LAN communication unit 32.

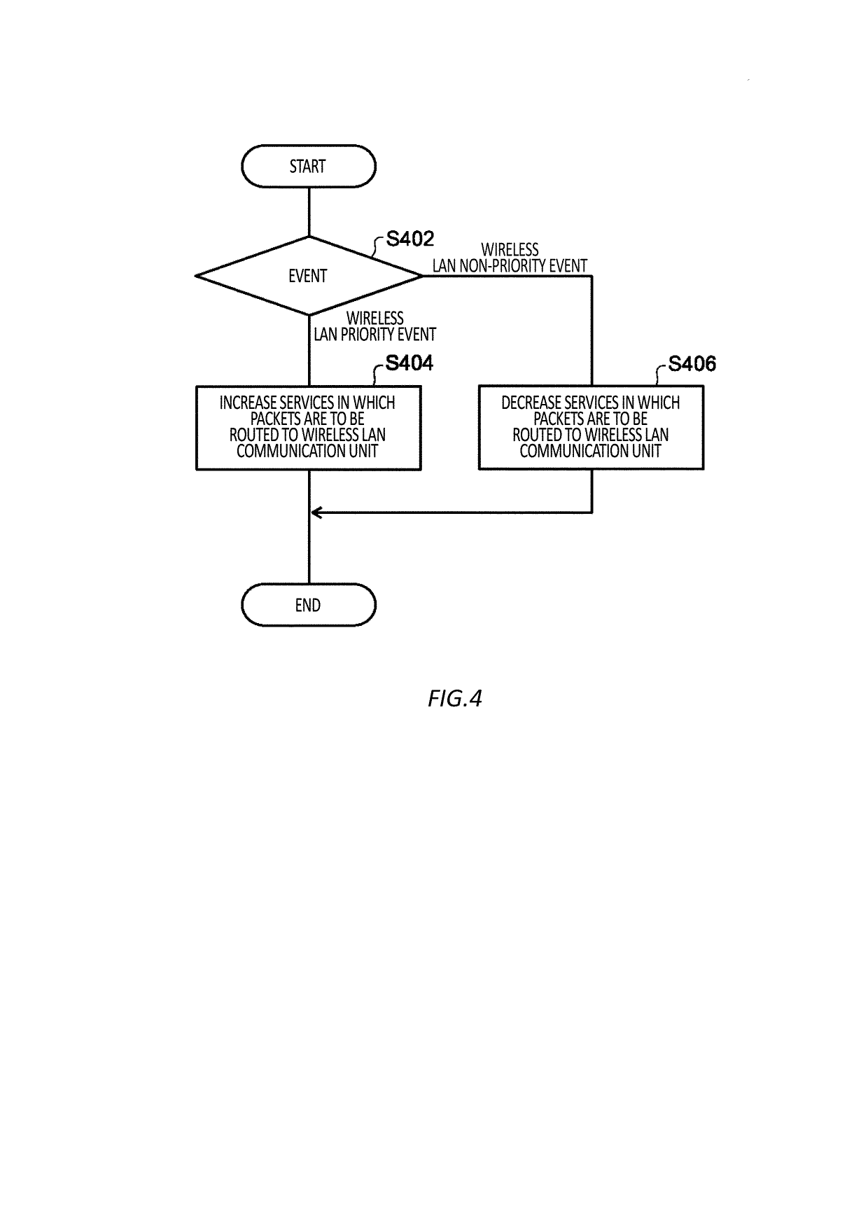

FIG. 4 illustrates an example of a flowchart according to a communication control method performed in the TCU 30. Processing of the present flowchart is started when an event of a predetermined type is detected in which communication to be routed to the wireless LAN communication unit 32 is to be increased or decreased. In FIG. 4, the event of the type in which the communication to be routed to the wireless LAN communication unit 32 is to be increased is referred to as a "wireless LAN priority event", and the event of the type in which the communication to be routed to the wireless LAN communication unit 32 is to be decreased is referred to as a "wireless LAN non-priority event".

In S402, the control unit 210 judges a type of the detected event and determines whether the detected event is the wireless LAN priority event or the wireless LAN non-priority event. The wireless LAN priority event includes at least one of an event representing that a speed of the movable body 20 becomes less than or equal to a predetermined first speed value, an event representing that a communication state of the cellular communication becomes poor, an event representing that an ignition power source of the movable body 20 is turned off, or an event representing that a communication state of the wireless LAN communication becomes good. The first speed value may be any speed value in a range, for example, from 10 km/h or more to 30 km/h or less. The wireless LAN non-priority event may include an event representing that the speed of the movable body 20 becomes greater than or equal to a predetermined second speed value and an event representing that the communication state of the wireless LAN communication becomes poor. The second speed value may be, for example, a speed value greater than or equal to 40 km/h. With regard to the communication state of the cellular communication and the communication state of the wireless LAN communication, the control unit 210 may determine whether each of the communication states is good or poor based on a received signal strength indicator (RSSI), a communication bandwidth, and/or a communicate speed, or the like.

In S402, when it is determined that the detect event is the wireless LAN priority event, in S404, the control unit 210 increases the services in which the packets are to be routed to the wireless LAN communication unit 32. For example, as described above, the control unit 210 may change the routing table such that among the services in which the packets are set to be routed to the cellular communication unit 31, the packets in connection to some of the services are to be routed to the wireless LAN communication unit 32. With this configuration, when a situation is established where it is possible to use the wireless LAN communication by priority, since the wireless LAN communication can be prioritized over the cellular communication, the communication costs can be reduced.

In S402, when it is determined that the detected event is the wireless LAN non-priority event, in S406, the control unit 210 decreases the services in which the packets are to be routed to the wireless LAN communication unit 32. For example, the control unit 210 may change the routing table such that among the services in which the packets are set to be routed to the wireless LAN communication unit 32, the packets in connection to some of the services are to be routed to the cellular communication unit 31.

As an example, the control unit 210 may change the routing table such that among the services in which the packets are set to be routed to the wireless LAN communication unit 32, at least some of the services which require a higher security level are selected by priority, and the packets in connection to the selected services are to be routed to the cellular communication unit 31. The control unit 210 may change the routing table such that among the services in which the packets are set to be routed to the wireless LAN communication unit 32, at least some of the services which require a higher immediacy are selected by priority, and the packets in connection to the selected services are to be routed to the cellular communication unit 31. As described above, in each of the services, request information representing the security level and immediacy requested to use each of the services is preset, and the control unit 210 may refer to the request information to specify a service in which the packets are to be routed to the cellular communication unit 31. When a situation is established where use of the wireless LAN communication by priority is not preferable, a communication amount of the wireless LAN communication can be decreased.

In the communication system 22 described above, the embodiment mode in which the communication control unit 33 includes the plurality of virtual routers has been described. However, an embodiment mode in which the communication control unit 33 includes a single virtual router may also be adopted. In this case, an embodiment mode may be adopted in which by controlling routing by the single virtual router, the control unit 210 causes the wireless LAN communication unit 32 by priority over the cellular communication unit 31 to perform routing. Similarly, an embodiment mode may be adopted in which by controlling the routing by the single virtual router, the control unit 210 causes the wireless LAN communication unit 32 by priority over the cellular communication unit 31 to perform routing for each service.

According to the communication system 22 described above, when the cellular communication through the wireless base station 120 and the wireless LAN communication through the wireless relay apparatus 110 are available, since the communication system 22 can prioritize the wireless LAN communication over the cellular communication, the communication costs can be reduced.

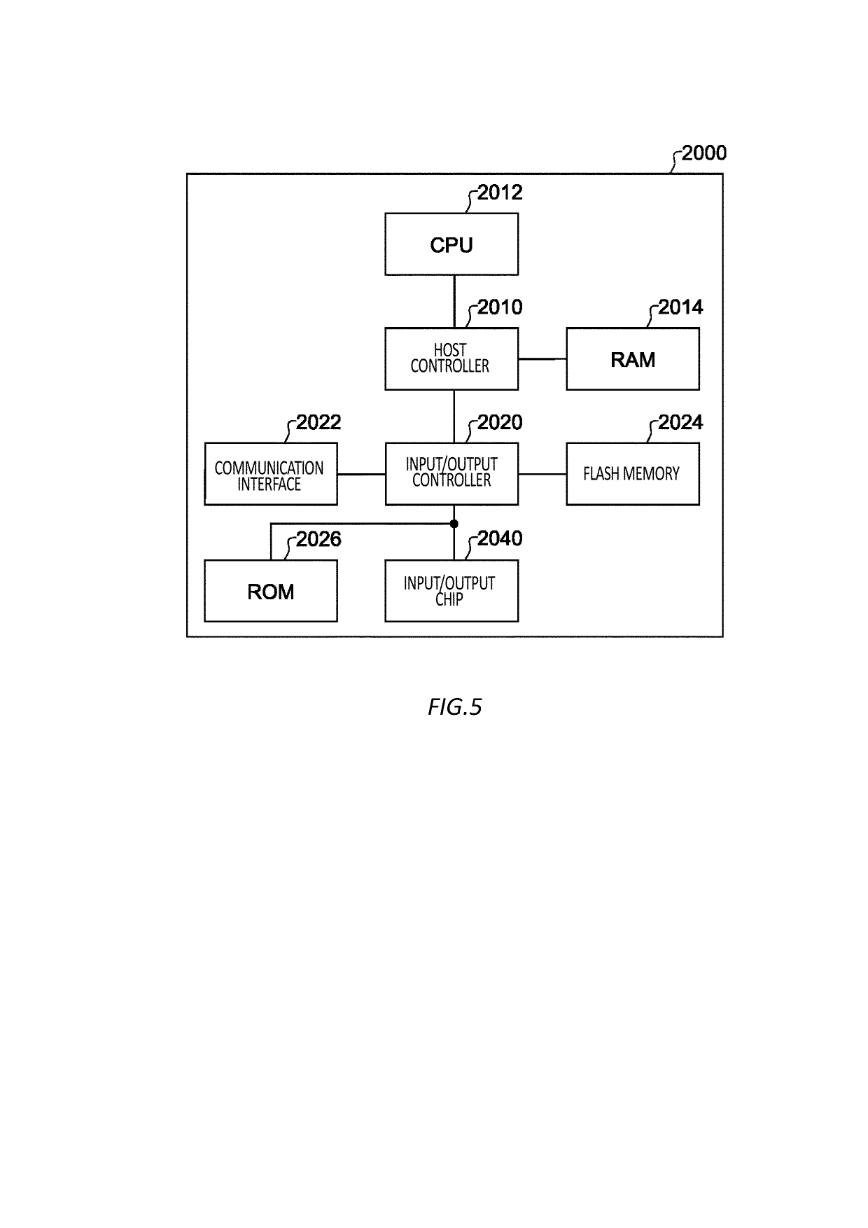

FIG. 5 illustrates an example of a computer 2000 in which a plurality of embodiments of the present invention can be embodied entirely or partially. Programs installed in the computer 2000 can cause the computer 2000 to function as the communication system 22 according to the embodiment or each unit of the system or various devices such as the TCU 30 or each unit of the device, to perform operations associated with the system or each unit of the system or the device or each unit of the device, and/or to perform a process according to the embodiment or a step of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 upon activation, and/or a program which depends on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer readable storage medium such as a CD-ROM, a DVD-ROM, or a memory card. The RAM 2014, the ROM 2026, or the flash memory 2024 is an example of the computer readable storage medium. The program is installed in the flash memory 2024, the RAM 2014, or the ROM 2026, and executed by the CPU 2012.Information processing written in these programs is read by the computer 2000, and provides cooperation between the programs and the various types of hardware resources described above. An apparatus or a method may be actualized by executing operations or processing of information according to a use of the computer 2000.

For example, when a communication is executed between the computer 2000 and an external device, the CPU 2012 may execute a communication program loaded on the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium. In addition, the CPU 2012 may cause all or a necessary portion of a file or a database stored in a recording medium such as the flash memory 2024 and the like to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The program or software module described above may be stored in a computer readable storage medium on the computer 2000 or near the computer 2000. A recording medium such as a hard disk or a RAM provided in a server system connected to a dedicated communication network or the Internet can be used as the computer readable storage medium. A program stored in the computer readable storage medium may be provided to the computer 2000 via a network.

When programs which are installed in the computer 2000 and cause the computer 2000 to function as the TCU 30 are performed by the computer, the computer 2000 may be caused to function as each unit of the TCU 30 by working with the CPU 2012 or the like. When information processing described in these programs are read by the computer 2000, the computer 2000 functions as each unit of the TCU 30 that is specific means in which software and various hardware resources described above cooperate with each other. These specific means implement operations or processing of information according to the intended use of the computer 2000 in the present embodiment, and the TCU 30 is thereby constructed to be specific for the intended use.

Various embodiments have been described with reference to the block diagrams and the like. In the block diagrams, each block may represent (1) a stage of a process in which an operation is executed, or (2) each unit of the apparatus having a role in executing the operation. A specific step and each unit may be implemented by a dedicated circuit, a programmable circuit supplied with computer readable instructions stored on a computer readable storage medium, and/or a processor supplied with computer readable instructions stored on a computer readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like such as a flip-flop, a register, a field programmable gate array (FPGA), a programmable logic array (PLA), or the like.

The computer readable storage medium may include any tangible device capable of storing instructions to be executed by an appropriate device. Thereby, the computer readable storage medium having instructions stored therein forms at least a part of a product including instructions which can be executed to provide means for executing processing procedures or operations specified in the block diagrams. An example of the computer readable storage medium may include an electronic storage medium, a magnetic storage medium, an optical storage medium, an electromagnetic storage medium, a semiconductor storage medium, etc. A more specific example of the computer readable storage medium may include a FLOPPY (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a BLU-RAY (registered trademark) disk, a memory stick, an integrated circuit card, or the like.

The computer readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object-oriented programming language such as SMALLTALK (registered trademark), JAVA (registered trademark), and C++, or the like, and a conventional procedural programming language such as a "C" programming language or a similar programming language.

The computer readable instructions are provided to a processor of a programmable data processing device such as a computer or programmable circuit locally or via a local area network (LAN) or a wide area network (WAN) such as the Internet, and the computer readable instructions may be performed to bring about means to perform the operations specified in the processing procedures or block diagrams which have been described.

Here, the computer may be a computer such as a personal computer (PC), a tablet computer, smartphone, a work station, a server computer, or a general purpose computer, or may be a computer system in which a plurality of computers are connected. Such a computer system to which the plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. In addition, which portion of the program each of the plurality of processors is to execute may be statically determined by multi-processor aware programming.

While the present invention has been described by way of the embodiments above, the technical scope of the present invention is not limited to the above-described embodiments. It is apparent to persons skilled in the art that various alterations or improvements can be made to the above-described embodiments. It is also apparent from description of the claims that the embodiments to which such modifications or improvements are made may be included in the technical scope of the present invention.

The operations, procedures, steps, and stages etc. of each process performed by a device, system, program, and method shown in the claims, specification, or diagrams can be executed in any order as long as the order is not indicated by "before", "prior to", or the like and as long as the output from a previous process is not used in a later process. Even if the operation flow is described using phrases such as "first" or "next" for the sake of convenience in the claims, specification, or drawings, it does not necessarily mean that the process must be performed in this order.

### EXPLANATION OF REFERENCES

20: movable body;

22: communication system;

30: TCU;

31: cellular communication unit;

32: wireless LAN communication unit;

33: communication control unit;

50: ECU;

60: ECU;

70: in-vehicle communication network;

90: communication network;

110: wireless relay apparatus;

120: wireless base station;

200: virtual router unit;

210: control unit;

220: bridge unit;

201: first virtual router;

202: second virtual router;

203: third virtual router;

310: first packet;

320: second packet;

330: third packet;

2000: computer;

2010: host controller;

2012: CPU;

2014: RAM;

2020: input/output controller;

2022: communication interface;

2024: flash memory;

2026: ROM; and

2040: input/output chip.

What is claimed is:

1. A communication control apparatus provided in a movable body including a cellular communication unit which performs cellular communication and a wireless LAN communication unit which performs wireless LAN communication, the communication control apparatus comprising:
a virtual router unit which decides to route communication to the cellular communication unit or to route communication to the wireless LAN communication unit; and
a control unit which performs control to communicate by prioritizing the wireless LAN communication over the cellular communication by controlling routing by the virtual router unit.

2. The communication control apparatus according to claim 1, wherein by controlling the routing by the virtual router unit, the control unit performs control to perform the cellular communication and the wireless LAN communication in parallel.

3. The communication control apparatus according to claim 1, wherein the movable body is a vehicle, andby controlling the routing by the virtual router unit, the control unit causes the wireless LAN communication unit by priority over the cellular communication unit to route communication other than communication related to travelling control of the vehicle.

4. The communication control apparatus according to claim 1, wherein the movable body is a vehicle, and by controlling the routing by the virtual router unit, the control unit causes the cellular
communication unit by priority over the wireless LAN communication unit to route communication related to travelling control of the vehicle.

5. The communication control apparatus according to claim 1, wherein the virtual router unit includes a plurality of virtual routers associated with mutually different APN settings.

6. The communication control apparatus according to claim 1, wherein the virtual router unit includes a plurality of virtual routers associated with mutually different services.

7. The communication control apparatus according to claim 1, wherein the virtual router unit includes a first virtual router which routes communication only to the cellular communication unit.

8. The communication control apparatus according to claim 1, wherein the virtual router unit includes a second virtual router which routes communicationtothe cellular communication unit and the wireless LAN communication unit, andthe control unit performs, by controlling the second virtual router, control to communicate by prioritizing the wireless LAN communicationover the cellular communication.

9. The communication control apparatus according to claim 1, wherein the virtual router unit includes a third virtual router which routes communication only to the wireless LAN communication unit.

10. The communication control apparatus according to claim 1, wherein when a predetermined event is detected, the control unit performs, by controlling the routing by the virtual router unit, the control to communicate by prioritizing the wireless LAN communication over the cellular communication.

11. The communication control apparatus according to claim 10, wherein the movable body is a vehicle, and the predetermined event includes at least one of an event representing that a speed of the vehicle becomes less than or equal to a predetermined speed value, an event representing that a communication state of the cellular communication becomes poor, or an event representing that an ignition power source of the vehicle is turned off.

12. The communication control apparatus according to claim 2, wherein the movable body is a vehicle, and by controlling the routing by the virtual router unit, the control unit causes the wireless LAN communication unit by priority over the cellular communication unit route communication other than communication related to travelling control of the vehicle.

13. The communication control apparatus according to claim 2, wherein the movable body is a vehicle, and by controlling the routing by the virtual router unit, the control unit causes the cellular communication unit by priority over the wireless LAN communication unit to route communication related to travelling control of the vehicle.

14. The communication control apparatus according to claim 2, wherein the virtual router unit includes a plurality of virtual routers associated with mutually different APN settings.

15. The communication control apparatus according to claim 2, wherein the virtual router unit includes a plurality of virtual routers associated with mutually different services.

16. The communication control apparatus according to claim 2, wherein the virtual router unit includes a first virtual router which routes communication only to the cellular communication unit.

17. The communication control apparatus according to claim 2, wherein the virtual router unit includes a second virtual router which routes communication to the cellular communication unit and the wireless LAN communication unit, and the control unit performs, by controlling the second virtual router, control to communicate by prioritizing the wireless LAN communication over the cellular communication.

18. The communication control apparatus according to claim 2, wherein the virtual router unit includes a third virtual router which routes communication only to the wireless LAN communication unit.

19. A communication control method executed by a communication control apparatus provided in a movable body including a cellular communication unit which performs cellular communication and a wireless LAN communication unit which performs wireless LAN communication, the communication control method comprising:
deciding, by a virtual router unit, to route communication to the cellular communication unit or to route communication to the wireless LAN communication unit; and
performing, by a control unit, control to communicate by prioritizing the wireless LAN communication over the cellular communication by controlling routing by the virtual router unit.

20. A non-transitory computer readable storage medium storing a program for a communication control apparatus provided in a movable body including a cellular communication unit which performs cellular communication and a wireless LAN communication unit which performs wireless LAN communication, the program causing a computer to function as:
a virtual router unit which decides to route communication to the cellular communication unit or to route communication to the wireless LAN communication unit; and
a control unit which performs control to communicate by prioritizing the wireless LAN communication over the cellular communication by controlling routing by the virtual router unit.
